(19) United States
(12) Patent Application Publication
(10) Pub. No.: US 2002/0107884 A1
(43) Pub. Date: Aug. 8, 2002

(54) Prioritizing and visually distinguishing sets of hyperlinks in hypertext world wide web documents in accordance with weights based upon attributes of web documents linked to such hyperlinks

(75) Inventors: Dwip N. Banerjee, Austin, TX (US); Rabindranath Dutta, Austin, TX (US)

Correspondence Address: Volel Emile, International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 09/779,357

(22) Filed: Feb. 8, 2001

(51) Int. Cl. G06F 17/21

(52) U.S. Cl. 707/501.1; 707/526

(57) ABSTRACT

A system through which the Web user may distinguish the more significant hyperlinks on each received Web document. Advantage is taken of the many Web search engines which already track and assign weights to Web documents based upon frequency of universal access, i.e. “hits”. This attribute of Web documents is the most frequently weighted and, of course, used by the search engines when they send their search reports with the Web document listed in the order of frequency of access. Thus, the invention involves the combination of an implement for determining a weight for each of said plurality of embedded hyperlinks in a received Web document and an implementation for prioritizing the plurality of embedded hyperlinks based upon said weights. Then, a set of the plurality of embedded hyperlinks are visually distinguished from each other based upon said prioritizing, whereby said user may select hyperlinks based upon said prioritizing. The implement for distinguishing may include, for example, highlighting such as color differences, brightness or blinking. Also, the priority set may appear as the only activated hyperlinks on the Web page while the other hyperlinks are receded back into the Web page and appear as ordinary text or images.

### TECHNICAL FIELD

The present invention relates to computer managed communication networks such as the World Wide Web (Web) and, particularly, to ease of use of interactive computer controlled display interfaces to receive hypertext documents with hyperlinks which interactively link users from such documents to other documents and programs.

### BACKGROUND OF RELATED ART

The 1990's decade has been marked by a technological revolution driven by the convergence of the data processing industry with the consumer electronics industry. The effect has, in turn, driven technologies which have been known and available but relatively quiescent over the years. A major one of these technologies is the Internet or Web related distribution of documents, media and programs. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of documents, media and computer programs.

In addition, Hypertext Markup Language (HTML), which had been the documentation language of the Internet or Web for years, offered direct links between pages and other documentation on the Web and a variety of related data sources which were at first text and then evolved into media, i.e. “hypermedia”. This even further exploded the use of the Internet or Web. It was now possible for the Web browser or wanderer to spend literally hours going through document after document in often less than productive excursions through the Web. These excursions often strained the users' time and resources. In order for the Internet to mature from its great expectations to solid commercial fruition, it will be necessary for the Internet to greatly reduce its drain on time and related resources. A significant source of this drain is in the Web page (the basic document page of the Web) itself.

In the case of Web pages, we do not have the situation of a relatively small group of professional designers working out the human factors. Rather, in the era of the Web, anyone and everyone can design a Web page. Pages are frequently designed by developers without usability skills. As a result, Web pages are frequently set up and designed in an eclectic manner. Often Web pages are set up through loose business, professional, social and educational configurations with general trade or public input of Web pages. The names or identifiers selected for the hyperlinks by Web page hosts or authors are often very similar to each other. As a result, the user going through one or a series of Web searches or browses will find it virtually impossible to recognize the more important hyperlinks to significant Web documents and pages. Thus, the user may spend considerable time going around in circles. The providers of Web searches have addressed this problem to some extent by tracking the frequency with which Web documents are accessed and often list the Web documents and pages in search results in the order in which such documents and pages are universally accessed or “hit” in past Web searches. However, once the user accesses a particular Web document or page, there is no guidance as to which hyperlinks on the received Web page are linked to Web documents of greater or lesser significance.

### SUMMARY OF THE PRESENT INVENTION

The present invention provides a simple and effective system through which the Web user may distinguish the more significant hyperlinks on each received Web document. The invention takes advantage of the situation that many Internet search engines already track and assign weights to Web documents based upon frequency of universal access, i.e. “hits”. This attribute of Web documents is the most frequently weighted and, of course, used by the search engines when they send their search reports with the Web document listed in the order of frequency of access. Thus, the invention involves the combination of means for determining a weight for each of the plurality of embedded hyperlinks in a received Web document and means for prioritizing a set of the plurality of embedded hyperlinks based upon these weights. Then, the invention provides means for visually distinguishing said plurality of embedded hyperlinks from each other based upon said prioritizing, whereby said user may select said hyperlinks based upon said prioritizing. The means for distinguishing may include highlighting such as color differences, brightness or blinking, for example. Also, the priority set may be presented as the only activated hyperlinks on the Web page while the other hyperlinks are receded back into the Web page and appear as ordinary text or images.

In addition to the Web document weight information available from the search engine which is conventionally based upon the activity of the Web document, the weighting of the document and, thus, the hyperlinks which represent it may be based upon the notoriety of the document. By notoriety is meant the weight as valued by the importance of the document. For example, a breakthrough scientific or medical paper may be accorded a high weight value. A document produced by a Nobel Prize winner could also deserve a high weight value.

Also, in accordance with a preferred aspect of the present invention, the receiving display station further includes a user interactive Web browser, and this Web browser includes the means for prioritizing said plurality of embedded hyperlinks based upon weights, and the means for visually distinguishing the plurality of embedded hyperlinks from each other based upon said prioritizing.

In accordance with another aspect of the present invention, the Web browser further includes means for prefetching from the Web hypertext documents respectively linked to the preferred set of hyperlinks prior to a user selection of any hyperlinks in said set. An example of such prefetching is described in copending patent application Ser. No. 09/306,197, John M. Mullaly et al., filed May 6, 1999, and assigned to the same assignee of the present invention.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter which is capable of functioning as a user interactive Web station for receiving and transmitting Web pages;

FIG. 2 is a generalized diagrammatic view of a Web portion showing how the Web may be accessed to and from the Web stations for the requesting Web pages and for prioritizing and visually distinguishing sets of hyperlinks on received Web documents;

FIG. 3 is a diagrammatic view of an illustrative received Web page in its normal state including all of its hyperlinks which will provide the illustrative example for the process of the present invention;

FIG. 4 is the diagrammatic view of FIG. 3 but with a prioritized set of the hyperlinks visually distinguished from other hyperlinks;

FIG. 5 is the diagrammatic view of FIG. 3 but with only the prioritized set of the hyperlinks appearing as hyperlinks and the other hyperlinks appearing just as normal text;

FIG. 6 is a general flowchart of a program set up to implement the present invention for the prioritizing and visual distinguishing of a set of the hyperlinks in a received Web page; and

FIG. 7 is a flowchart of an illustrative run of the program set up in FIG. 4.

### DETAILED DESCRIPTION OF THE PREFERRED EMBODIMENT

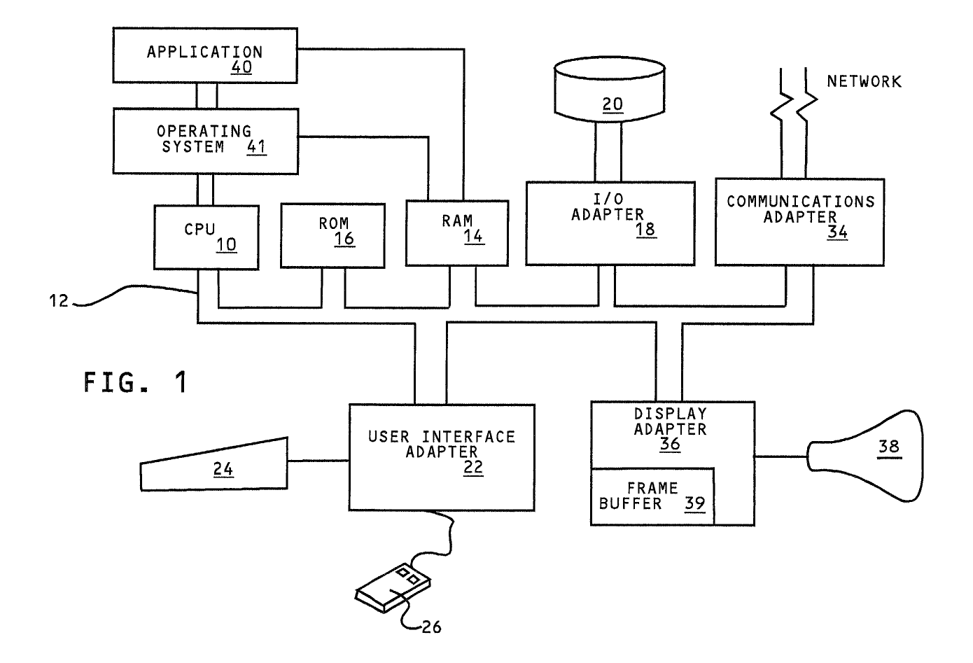

Referring to FIG. 1, a typical data processing terminal is shown which may function as the computer controlled network terminal or Web display station used for receiving Web pages, for requesting Web searches and for Web browsing.

A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows98™ or Windows NT™, as well as the UNIX and AIX operating systems. Application programs 40, controlled by the system, are moved into and out of the main memory Random Access Memory (RAM) 14. These programs include the programs of the present invention for the prioritizing of hyperlinks in received Web documents and the visual distinguishing of sets of said prioritized hyperlinks to be subsequently described in combination with any conventional Web browser, such as the Netscape Navigator 3.0™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with the Web or Internet. The latter two terms are meant to be generally interchangeable and are so used throughout this application and in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods which may be related to the present invention. Since a major aspect of the present invention is directed to Web pages transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999.

Any data communication system which interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers. These network servers are the key to network distribution, such as the distribution of Web pages and related documentation. Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly at pp. 637-642, on HTML in the formation of Web pages. In addition, aspects of this invention will involve Web browsers. A general and comprehensive description of browsers may be found in the above-mentioned Mastering the Internet text at pp. 291-313. More detailed browser descriptions may be found in the above-mentioned Internet: Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

The invention will also use search engines for searching. As described in the Internet, Milleniun Edition text, pages 395 and 522-535, search engines use keywords and phrases to query the Web for desired subject matter. Usually the keywords used in designing Web queries may be combined with some of the basic Boolean operators: AND, OR and NOT. Each search engine has its own well developed syntax or rules for combining such Boolean operators with the keywords to conduct the searches. The search engine is a database application that retrieves information according to its own syntax. The search engine usually uses a search agent, called a “spider” that looks for information on Web pages. Such information is indexed and stored in a vast database. In carrying out its search, the search engine looks through the database for matches to keywords subject to the engine syntax. The search engine then presents to the user a list of the Web pages it determines to be closest to the requested query. Some significant search engines are: AltaVista, Infoseek, Lycos, Magellan, Webcrawler and Yahoo.

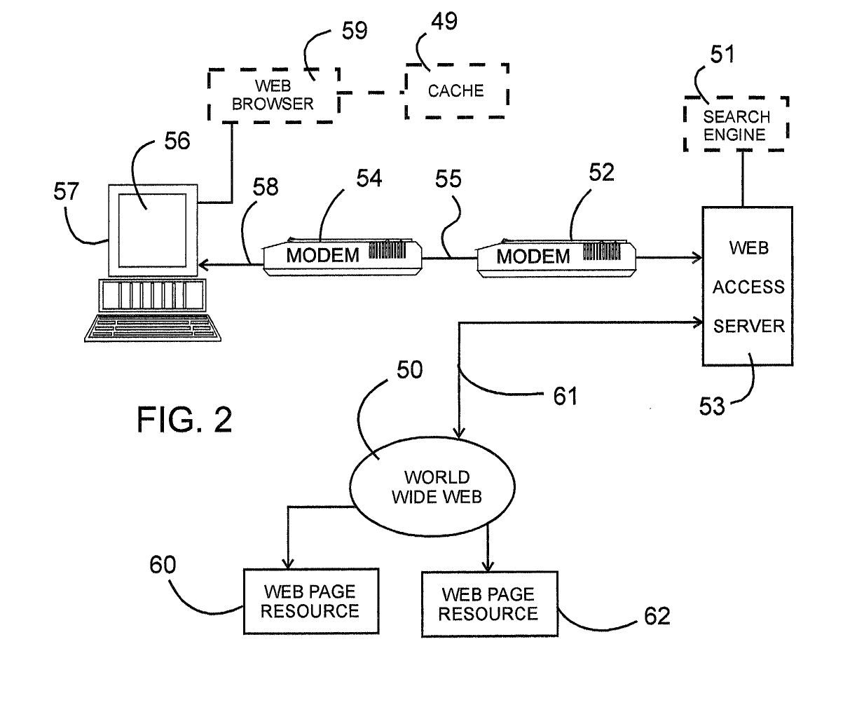

A generalized diagram of a portion of the Internet, which the computer controlled display terminal 57 used for Web page receiving during searching or browsing, is connected as shown in FIG. 2. Computer display terminal 57 may be implemented by the computer system setup in FIG. 1 and connection 58 (FIG. 2) is the network connection shown in FIG. 1. For purposes of the present embodiment, computer 57 serves as a Web display station and has received displayed Web page 56, which is one of a sequence of Web pages containing embedded hyperlinks to other Web pages.

Reference may be made to the above-mentioned Mastering the Internet, pp. 136-147, for typical connections between local display stations to the Web via network servers, any of which may be used to implement the system on which this invention is used. The system embodiment of FIG. 2 has a host-dial connection. Such host-dial connections have been in use for over 30 years through network access servers 53, which are linked 61 to the Web 50. The servers 53 may be maintained by a service provider to the client's display terminal 57. The host's server 53 is accessed by the client terminal 57 through a normal dial-up telephone linkage 58 via modem 54, telephone line 55 and modem 52. The HTML file representative of the Web page 56 has been downloaded to display terminal 57 through Web access server 53 via the telephone line linkages from server 53, which may have accessed them from the Internet 50 via linkage 61. The Web browser program 59 operates within the display terminals 57 computer to control the communication with the Web access server 53 to thereby download and display the accessed Web pages 56 on terminal 57. The Web access server 53 uses one of the previously described search engines to access via the Web 50 and the desired sequence of Web pages from appropriate Web resources, such as databases 60 and 62.

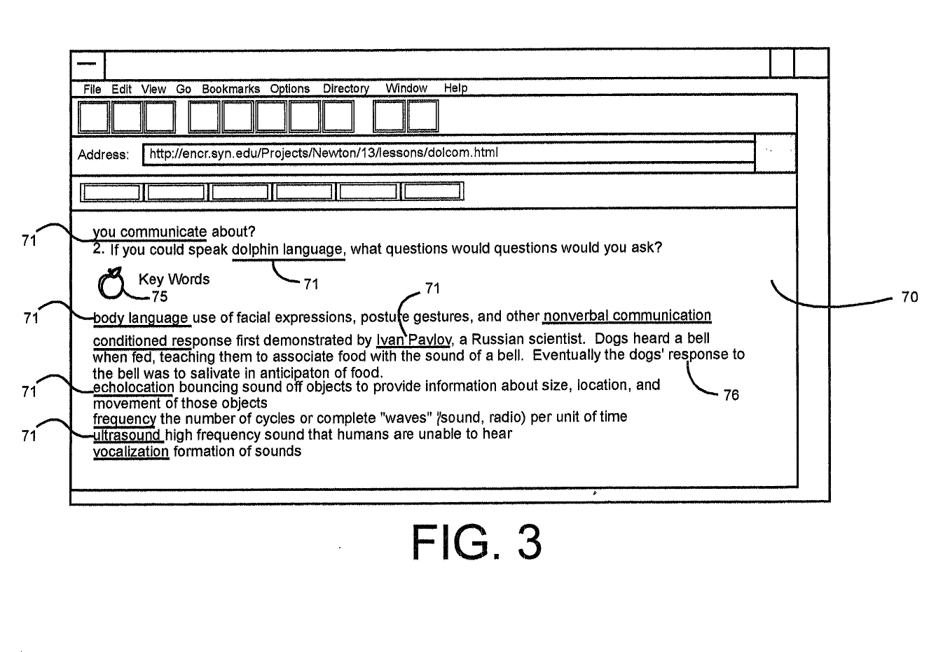

With this setup, the present invention, which will be subsequently described in greater detail with respect to FIGS. 3 through 7, may be carried out using search engine 51, as well as Web browser 59 in FIG. 2. As search engine 51 accesses the sequence of Web pages and provides such pages to the user at terminal 57, the search engine also has available, for substantially each of the documents which may be accessed through the search engine, a weighted value for the document. Usually, this weight is based upon the frequency with which the Web document has been accessed by the world in general. As will be hereinafter described, the Web browser 59 at a receiving display station has the capability of applying the weighted values of such documents to the hyperlinks to such Web documents found in other Web documents to thereby prioritize such hyperlinks and to visually distinguish a set of such prioritized hyperlinks from other hyperlinks. It should be noted that there are resources, such as resources 60 and 62, which include databases, maintaining some information about the relative weight values of items of data. For example, in determining a weight value, information from recognized academic or business sources may be accorded a higher value than perhaps data input from little known individuals. Browser 59 can obtain any such weight information to use in the present prioritizing. Browser 59 has an associated storage cache 49 in which prefetched Web documents linked to the higher priority set of hyperlinks may be stored until used.

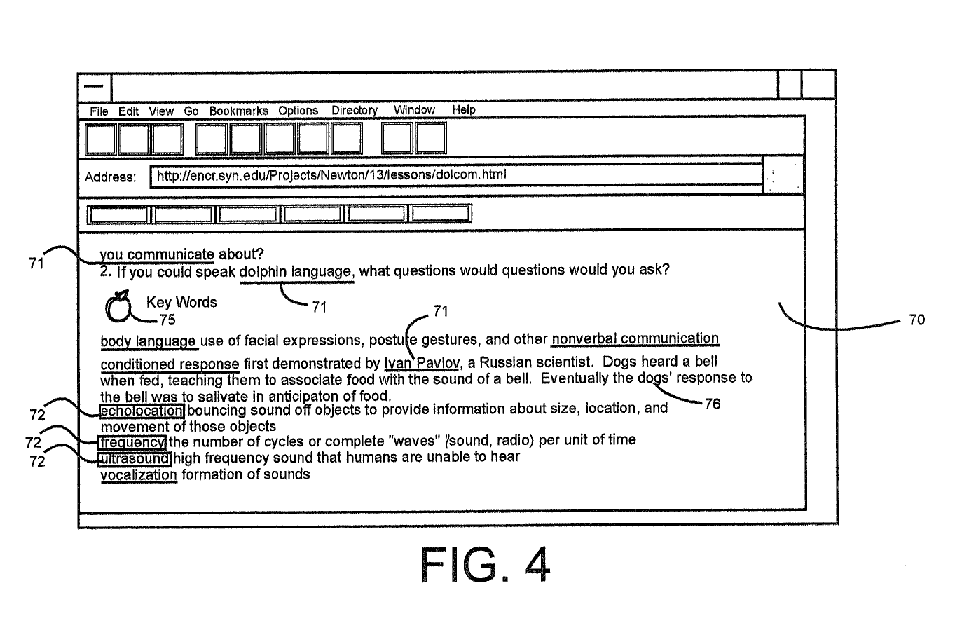

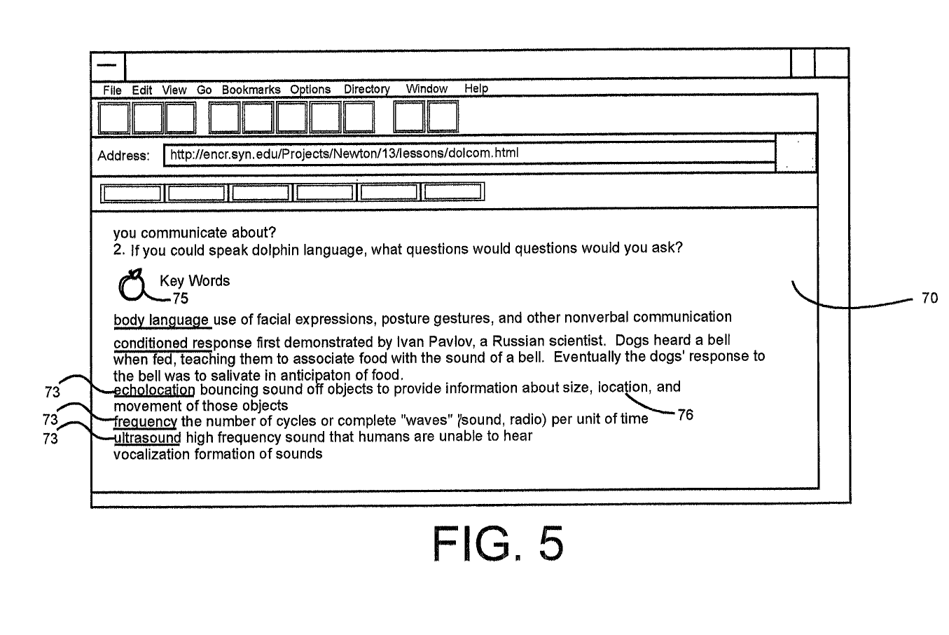

The advantages of the present invention may be readily seen with respect to FIGS. 3 through 5, which are diagrams of illustrative Web pages used in the practice of the present invention. A typical Web page 70 which may be received via the Web is shown in FIG. 3. It contains hyperlinks such as terms 71. On the present received page 70, the hyperlinks have been underlined to designate them as hyperlinks. The page also contains, of course, text 76 and image 75. After the page is received, the Web browser, using available Web document weight data including any information available from the search engine and from Web resource databases, as well as any document weight information which the browser itself may have available, prioritizes the hyperlinks based upon the relative weights determined for the Web documents which the hyperlinks respectively represent and are linked to. From this data, as will hereinafter be described in greater detail, the browser designates a set of higher priority hyperlinks 72, which are shown as highlighted in FIG. 4. This leads the user to first access through the hyperlinks 72 in this priority set. This highlighting may be achieved, for example, through color, brightness or blinking. A variation on this highlighting is shown in FIG. 5 wherein the browser removes the indicators for all of the other hyperlinks so that only hyperlinks 73 in the high priority set are shown as hyperlinks. This may be done after the received Web page is displayed with all hyperlinks 71 in FIG. 3 or the browser may be set up to directly display only the priority set of hyperlinks 73, FIG. 5, as soon as the Web page 70 is received from the Web.

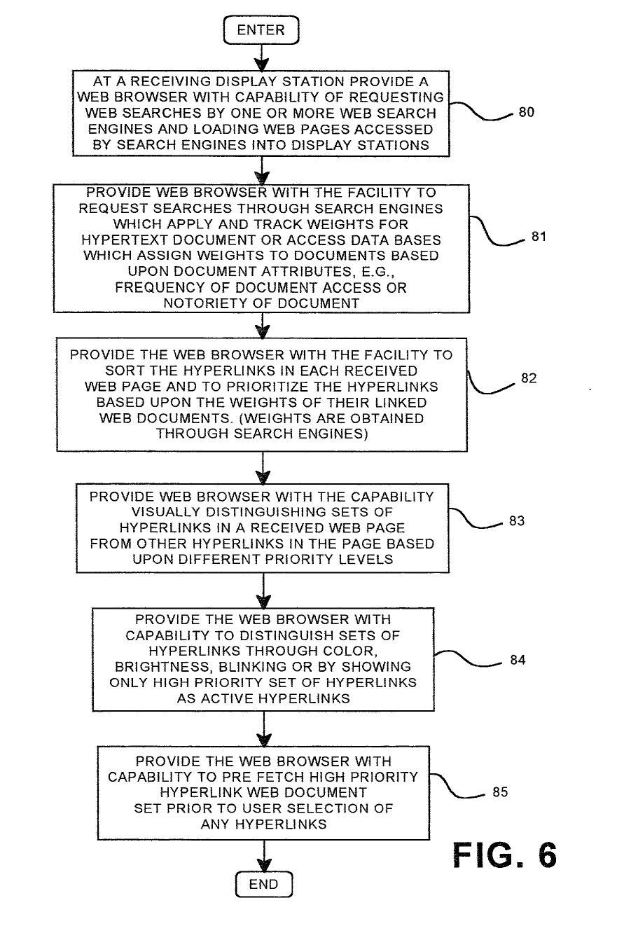

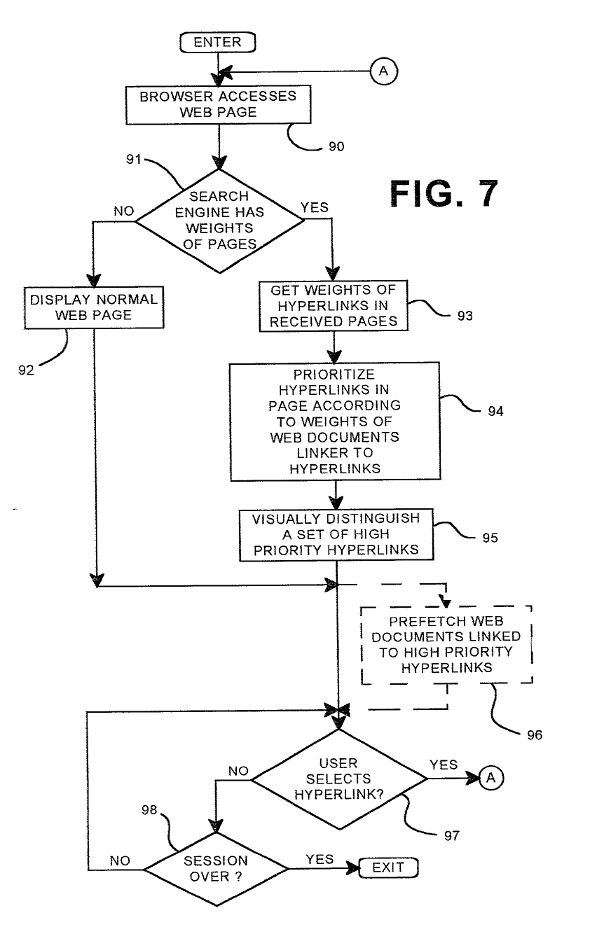

Now, with reference to FIGS. 6 and 7, we will describe a process implemented by the present invention in conjunction with the flowcharts of these figures. FIG. 6 is a flowchart showing the development of a process according to the present invention for prioritizing a set of hyperlinks in a received Web document and visually distinguishing said set of hyperlinks. A Web browser is provided at a receiving display station on the Web for accessing Web pages in the conventional manner and loading them at the display station, step 80. The Web browser has the capability of requesting searches from one or more search engines available through the Web. The browser has the further capability of requesting those search engines which apply and track weights to Web documents to provide such weights for the assigned Web documents linked to the hyperlinks in received Web pages or documents, step 81. The browser can also obtain such weights which may be tracked by Web resource databases, which also assign and track such weights.

The browser is provided with the further capability of sorting the hyperlinks in each received Web document and prioritizing such hyperlinks based upon the weights of their linked Web documents, step 82 (such weights are often obtainable through the search engines). The browser is also provided with the capability of visually distinguishing sets of hyperlinks of selected priority levels from the other hyperlinks on the displayed received Web page, step 83. The browser is further provided, step 84, with the capability to distinguish sets of hyperlinks through color, brightness, blinking or by showing only the high priority hyperlinks as active hyperlinks (FIG. 5). Finally, the browser is provided with the capability to prefetch the high priority hyperlink documents which are linked to the set of hyperlinks prior to any user selection of any hyperlinks to thereby further speed up the selection and access times for receiving Web documents, step 85.

The running of the process setup in FIG. 6 and described in connection with FIGS. 3 through 5 will now be described with respect to the flowchart of FIG. 7. The browser accesses a Web page at the receiving display station, step 90. A determination is made at the browser as to whether the search engine can provide any information as to the relative weights of the Web documents linked to the hyperlinks in the received Web page, step 91. If No, the received Web page is displayed in the conventional manner, step 92. If Yes, then the browser gets from the search engine, the weights of the Web documents linked to the hyperlinks in the received Web page, step 93. The Web browser then prioritizes the hyperlinks according to the weights of the linked Web documents, step 94. The browser then visually highlights a set of higher priority hyperlinks on the received Web page, step 95. Optionally, as shown by the dashed lines, the browser may also prefetch off the Web, the Web documents linked to the highlighted set of hyperlinks, step 96. Now the user may work with the highlighted received Web page. A determination is then made as to whether the user has selected a hyperlink to a Web document, step 97. If Yes, the process is branched via “A” back to step 90 where the linked Web page is accessed and displayed and the process is continued from that point. If No, then a further determination is made, step 98, as to whether the session is over. If No, the process returns to step 97 where a user selection of a hyperlink is awaited. If the determination from step 98 is Yes, the session is ended and exited.

One of the preferred implementations of the present invention is in application program 40, i.e. a browser program made up of programming steps or instructions resident in RAM 14, FIG. 1, of a Web receiving station during various Web operations. Until required by the computer system, the program instructions may be stored in another readable medium, e.g. in disk drive 20, or in a removable memory such as an optical disk for use in a CD ROM computer input, or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims. For example, the principles of the present invention would be readily applicable to wireless communication networks, similar to the Web.

What is claimed is:

1. In a World Wide Web (Web) communication network with user access via a plurality of data processor controlled interactive receiving display stations for displaying received hypertext documents of at least one display page containing text, images and a plurality of embedded hyperlinks, each hyperlink being user selectable to access and display a respective linked hypertext document, a system for prioritizing said plurality of embedded hyperlinks in each received hypertext document comprising:
means for determining a weight for each of said plurality of embedded hyperlinks,
means for prioritizing said plurality of embedded hyperlinks based upon said weights, and
means for visually distinguishing said plurality of embedded hyperlinks from each other based upon said prioritizing, whereby said user may select said hyperlinks based upon said prioritizing.

2. The Web communication network system of claim 1 wherein said means for visually distinguishing said hyperlinks include means for selectively highlighting a set of said plurality of embedded hyperlinks.

3. The Web communication network system of claim 2 wherein said means for selectively highlighting said set of hyperlinks include means for varying the brightness of said set of hyperlinks.

4. The Web communication network system of claim 2 wherein said means for selectively highlighting said set of hyperlinks include means for varying the color of said set of hyperlinks.

5. The Web communication network system of claim 2 wherein said means for selectively highlighting said set of hyperlinks includes means for selectively blinking said set of hyperlinks.

6. The Web communication network system of claim 2 wherein said means for selectively highlighting said set of hyperlinks include means for only activating said set of hyperlinks.

7. The Web communication network system of claim 1 wherein said means for determining a weight for each of said plurality of embedded hyperlinks determines said weight based upon an attribute of the hypertext document linked to each hyperlink.

8. The Web communication network system of claim 7 wherein said attribute is the frequency with which the linked hypertext document is universally accessed from the Web.

9. The Web communication network system of claim 7 wherein said attribute is the notoriety of the linked hypertext document.

10. The Web communication network system of claim 1 further including:
a Web search engine, and
wherein said means for determining the weight of each of said plurality of embedded hyperlinks is in said search engine.

11. The Web communication network system of claim 1 wherein at least one of said receiving display stations further includes a user interactive Web browser, said Web browser including:
said means for prioritizing said plurality of embedded hyperlinks based upon said weights, and
said means for visually distinguishing said plurality of embedded hyperlinks from each other based upon said prioritizing.

12. The Web communication network system of claim 11 wherein said means for visually distinguishing said plurality of embedded hyperlinks includes means for selectively highlighting a set of said plurality of embedded hyperlinks.

13. The Web communication network system of claim 12 wherein said Web browser further includes means for prefetching from the Web hypertext documents respectively linked to said set of hyperlinks prior to a user selection of any hyperlinks in said set.

14. In a Web communication network with user access via a plurality of data processor controlled interactive receiving display stations for displaying received hypertext documents of at least one display page containing text, images and a plurality of embedded hyperlinks, each hyperlink being user selectable to access and display a respective linked hypertext document, a method for prioritizing said plurality of embedded hyperlinks in each received hypertext document comprising:
determining a weight for each of said plurality of embedded hyperlinks,
prioritizing said plurality of embedded hyperlinks based upon said weights, and
visually distinguishing said plurality of embedded hyperlinks from each other based upon said prioritizing, whereby said user may select said hyperlinks based upon said prioritizing.

15. The method of claim 14 wherein said step of visually distinguishing said hyperlinks includes selectively highlighting a set of said plurality of embedded hyperlinks.

16. The method of claim 15 wherein said step of selectively highlighting said set of hyperlinks includes varying the brightness of said set of hyperlinks.

17. The method of claim 15 wherein said step of selectively highlighting said set of hyperlinks includes varying the color of said set of hyperlinks.

18. The method of claim 15 wherein said step of selectively highlighting said set of hyperlinks includes blinking said set of hyperlinks.

19. The method of claim 15 wherein said step of selectively highlighting said set of hyperlinks includes only activating said set of hyperlinks.

20. The method of claim 14 wherein said step of determining a weight for each of said plurality of embedded hyperlinks determines said weight based upon an attribute of the hypertext document linked to each hyperlink.

21. The method of claim 20 wherein said attribute is the frequency with which the linked hypertext document is universally accessed from the Web.

22. The method of claim 20 wherein said attribute is the notoriety of the linked hypertext document.

23. The method of claim 14 further including:
a Web search method including said step of determining the weight of each of said plurality of embedded hyperlinks.

24. The method of claim 14 further including a Web browser method operatively associated with at least one of said receiving display stations, said Web browser method including said steps of:
prioritizing said plurality of embedded hyperlinks based upon said weights, and
visually distinguishing said plurality of embedded hyperlinks from each other based upon said prioritizing.

25. The method of claim 24 wherein said step of visually distinguishing said plurality of embedded hyperlinks includes selectively highlighting a set of said plurality of embedded hyperlinks.

26. The method of claim 25 wherein said Web browser method further includes the step of prefetching from the Web hypertext documents respectively linked to said set of embedded hyperlinks prior to a user selection of any of said set of hyperlinks.

27. A computer program having code recorded on a computer readable medium for prioritizing a plurality of embedded hyperlinks in each received hypertext document in a Web communication network with user access via a plurality of data processor controlled interactive receiving display stations for displaying said received hypertext documents including a sequence of at least one display page containing text, images and a plurality of embedded hyperlinks, each hyperlink being user selectable to access and display a respective linked hypertext document, said program comprising:
means for determining a weight for each of said plurality of embedded hyperlinks,
means for prioritizing said plurality of embedded hyperlinks based upon said weights, and
means for visually distinguishing said plurality of embedded hyperlinks from each other based upon said prioritizing, whereby said user may select said hyperlinks based upon said prioritizing.

28. The computer program of claim 27 wherein said means for visually distinguishing said hyperlinks includes means for selectively highlighting a set of said plurality of embedded hyperlinks.

29. The computer program of claim 28 wherein said means for selectively highlighting said set of hyperlinks includes means for varying the brightness of said set of hyperlinks.

30. The computer program of claim 28 wherein said means for selectively highlighting said set of hyperlinks includes means for varying the color of said set of hyperlinks.

31. The computer program of claim 28 wherein said means for selectively highlighting said set of hyperlinks includes means for selectively blinking said set of hyperlinks.

32. The computer program of claim 28 wherein said means for selectively highlighting said set of hyperlinks include means for only activating said set of hyperlinks.

33. The computer program of claim 27 wherein said means for determining a weight for each of said plurality of embedded hyperlinks determines said weight based upon an attribute of the hypertext document linked to each hyperlink.

34. The computer program of claim 33 wherein said attribute is the frequency with which the linked hypertext document is universally accessed from the Web.

35. The computer program of claim 33 wherein said attribute is the notoriety of the linked hypertext document.

36. The computer program of claim 27 further including:
a Web search program, and
wherein said means for determining the weight for each of said plurality of embedded hyperlinks is in said search program.

37. The computer program of claim 27 wherein at least one of said receiving display stations further includes a user interactive Web browser program including:
said means for prioritizing said plurality of embedded hyperlinks based upon said weights, and
said means for visually distinguishing said plurality of embedded hyperlinks from each other based upon said prioritizing.

38. The computer program of claim 37 wherein said means for visually distinguishing said plurality of embedded hyperlinks includes means for selectively highlighting a set of said plurality of embedded hyperlinks.

39. The computer program of claim 38 wherein said Web browser further includes means for prefetching from the Web hypertext documents respectively linked to said set of hyperlinks prior to a user selection of any hyperlinks in said set.
